(19) United States
(12) Patent Application Publication
(10) Pub. No.: US 2013/0323449 A1
(43) Pub. Date: Dec. 5, 2013

(54) Oxygen Compounds as Plasticizers for Rubbers

(71) Applicants: Cristina Bergmann, Hamburg (DE); Jürgen Trimbach, Reinbek (DE)

(72) Inventors: Cristina Bergmann, Hamburg (DE); Jürgen Trimbach, Reinbek (DE)

(73) Assignees: H&R ÖLWERKE SCHINDLER GMBH, Hamburg (DE); TUDAPETROL MINERALÖLERZEUGNISSE NILS HANSEN KG, Hamburg (DE)

(21) Appl. No.: 13/884,653

(22) PCT Filed: Nov. 11, 2011
(86) PCT No.: PCT/EP2011/005681

§ 371 Date: May 10, 2013

(30) Foreign Application Priority Data
Nov. 12, 2010 (EP) 10014542.4

(51) Int. Cl. C08K 5/101

(52) U.S. Cl. CPC C08K 5/101
USPC 428/36.8; 524/318

(57) ABSTRACT

The invention relates to the use of fatty acid esters, either unsaturated or saturated, as plasticizers for rubbers, especially for NBR and CR rubbers. The plasticizers used according to the invention are safe, in contrast to the conventionally used toxic phthalates such as DEHP and DBP, and can be obtained from renewable raw materials, especially from vegetable oils such as palm oil. For rubbers comprising these plasticizers, there is a multitude of possible uses in the rubber technology sector, especially as a material for cable sheathing, hoses, seals, membranes, shoe soles, floor coverings, damping devices and the like.

This application claims priority from PCT/EP2011/005681 (WO 2012/062474), filed Nov. 11, 2011, and from European application 1001 4542.4, filed Nov. 12, 2010, and the entire contents of these applications are incorporated herein by reference.

### FIELD OF THE INVENTION

The invention relates to rubbers comprising oxygen-containing compounds made of renewable resources as plastizicers, in particular acrylonitrile-butadiene rubbers and chloroprene rubbers, and to the use of these rubbers comprising the oxygen-containing plastizicers.

A variety different rubbers are available. Key groups are the NBR (nitrile butadiene rubbers) and CR (chloroprene rubbers) rubbers, which are used in the field of technical rubber products.

NBR rubbers are typically obtained by polymerizing approximately 15 to 50 mol percent acrylonitrile and in the corresponding manner 85 to 50 mol percent 1,3-butadiene. NBR rubbers exhibit outstanding resistance to mineral oil and fuel. The individual polymer chains are linked to each other by polar nitrile side chains, whereby a barrier is created, which nonpolar liquids cannot overcome. Because of the polarity that stems from the nitrile groups. NBR rubbers essentially do not become electrostatically charged. There is no sparking, so that NBR rubbers can be used in particular for fuel hoses and seals in tank blacks, but also for seals in oil-lubricated machines. Other application options include rotary shaft seals, sealing elements for hydraulics or pneumatics, and O-rings. The thermal application range of NBR rubbers is between approximately −30 and +100° C., depending on the mixture. Over short periods, articles made of NBR rubbers can also be exposed to slightly higher temperatures. NBR rubbers exhibit cold-temperature flexibility as to as approximately −55° C.

CR rubbers are typically obtained by the emulsion polymerization of 2-chloro-1,3-butadiene at approximately 20 to 50° C. They have good abrasion resistance and impact resistance, CR rubbers exhibit good resistance to waxes, greases and non-aromatic hydrocarbons, while they are not resistant to chlorine-containing solvents. Because of the high chlorine content. CR rubbers are flame resistant and have a low tendency toward sparking. As a result, they are used in particular for cable sheathing. Other fields of applications include hoses, seals, drive belts, conveyor belts or, in foamed form, as a material for diving suits.

During the production and processing of rubbers, both of natural rubbers and synthetic rubbers, plastizicers are typically admixed as additives so as to influence the processability of the rubber, and also so as to adjust the later properties of the macromolecular material in a targeted manner. Plasticizers influence important mechanical properties such as tensility, softness, flexibility and elasticity of the rubber. In addition to the “plasticizing effect”, a plastizicer is expected in particular to become homogeneously distributed in the rubber compound so as to assure consistent product properties, and to have the lowest possible toxicity and harmfulness to the environment.

The use of vegetable oils, comprising at least one glycerol oleic acid triester, as plastizicers for rubber mixtures comprising at least one diene elastomer is known from the European patent EP 1 379 586 B1. Such an oil is, for example, sunflower oil, preferably comprising the oleic acid in a mass fraction of at least 70%.

The plastizicers that have been used most frequently until now are arguably phthalates, in particular DEHP (bis(2-ethylhexyl)phthalate) and DBP (dibutyl phthalate). These do not form a chemical bond with plastic materials and, as a result, can leak over time. However, in terms of ecological and toxic risks, this is extremely alarming because these phthalates have been classified as being highly toxic.

This was the reason for Directive 2005/84/EC of Dec. 14, 2005 to be adopted, in which the six phthalates DEHP, DBP, BBP (benzyl butyl phthalate), DINP (di-isononyl phthalate), DIDP (di-isodecyl phthalate) and DNOP (di-n-phthalate) are listed as hazardous substances. This directive also specifies that toys and baby articles containing more than 0.1% by weight DEHP, DBP or BBP must no longer be placed into circulation.

### SUMMARY OF THE INVENTION

It is thus the object of the invention to provide plastizicers that are suitable for rubbers, in particular for NBR and CR rubbers, and that are toxicologically safe to an extent as great as possible, yet are comparable to the conventionally used phthalates at least in terms of their properties as plastizicers. The object was therefore that of providing rubbers that comprise toxicologically safe plastizicers, however wherein the mechanical properties of these rubbers are to be comparable to or better than with rubbers comprising conventional plastizicers, notably phthalates.

The object is achieved according to the invention by a rubber, in particular selected from the group of nitrile rubbers and chloroprene rubbers, comprising at least one plastizicer, the plasticizer being an oxygen-containing compound characterized in that the oxygen-containing compound is a fatty acid ester of the general formula R¹—COOR², where R¹ is an alkyl radical or an alkenyl radical having 11 to 21 carbon atoms, and R² is a linear or branched alkyl radical having 1 to 12 carbon atoms or a pentaerythritol group. If R² is an alkyl radical, R² is preferably a linear or branched alkyl radical having 1 to 11 carbon atoms, notably a methyl, ethyl, isopropyl, 2-ethylhexyl or octyl radical.

Additional embodiments are described hereafter.

### DETAILED DESCRIPTION

Surprisingly it has been found that fatty acid esters have effects on rubbers that are comparable, and in some instances even superior, effects to those of the phthalates conventionally used as plastizicers, wherein based on current knowledge, contrary to many phthalates, fifty acid esters are toxicologically safe. It has been shown that the esters of both saturated, and of unsaturated fatty acids are suitable as plasticizers for rubbers, in particular for NBR and CR rubbers. As is known, saturated fatty acid esters are those in which the hydrocarbon chains have no double bonds, and which thus are formally derived from alkanes, while unsaturated fatty acid esters have one or more double bonds. Fatty acid esters are particularly advantageous as plastizicers because not only can these be synthesized, but they are also available as “renewable resources” in nature. In principle, all vegetable oils and animal fats are suited for producing these plastizicers. Typical vegetable oils that serve as sources for plastizicers that are used according to the invention are rapeseed oil, eruca rapeseed oil, high oleic sunflower oil (oleic acid content of 80 to 92%), palm oil, linseed oil, globe thistle oil and soy bean oil. In addition to vegetable oils, however, the plastizicers that are used according to the invention can also be obtained from fish oil, for example.

Saturated fatty add esters that are suited as plastizicers according to the invention include, for example, palmitic and stearic acid esters, suitable unsaturated fatty acid esters are notably oleic acid, linoleic acid, linolenic acid and erucic acid esters, and the mixtures thereof. Examples of such plastizicers are methyl oleate, ethyl oleate, 2-ethylhexyl oleate, pentaerythritol dioleate, pentaerythritol tetraoleate, 2-ethylhexyl stearate, 2-ethylhexyl linoleate or 2-ethylhexyl linoleate.

The person skilled in the art will know methods so as to obtain plastizicers that are used according to the invention from natural resources, but also synthetically.

Such a method is the transesterification of triglycerides with monohydric alcohols that is catalyzed under basic conditions, for example. The transesterification of triglycerides with branched or long-chain alcohols requires a 2 to 4-fold excess, preferably a 3-fold excess, of the stoichiometrically required amount of alcohol.

The total amount of oxygen-containing plastizicer according to the invention in the rubber is preferably 1 to 15 phr, with 1 to 10 phr being particularly preferred. The abbreviation “phr” denotes “parts per hundred pans rubber”.

The object is further achieved by the use of a rubber according to the invention for technical rubber products, such as for hoses, cable sheathing, seals, membranes, shoe soles, floor coverings, and damping devices.

The invention will be described based on the following examples, without being limited thereto.

### EXAMPLES

The following raw materials were employed:

Perbunan® 3945 is a commercial product made by Lanxess Deutschland GmbH (acrylonitrile content: 39% by weight, Mooney viscosity (100° C. (ML 1+4), without treatment): 45±5 MU), and Krynac® 3345F is likewise a commercial product available from Lanxess Deutschland GmbH (acrylonitrile content: 33% by weight, Mooney viscosity (100° C. (ML 1+4), without treatment); 45±5 MU), Vulkanox MB2/MG (4- and 5-methyl-2mercapto-benzimidazole (MMBI)) and Vulkanox HS/LG (2,2,4-trimethyl-1,2-dihydroquinoline, polymerized (TMQ)) are also commercial products available from Lanxess Deutschland GmbH. “ZnO active” is a commercial product available from Grillo Zinkoxid GmbH. The stearic acid is a commercial product available from Schill+Seilacher Struktol. The dark fillers Corax® N660, N550, N772 and Thermal Black MT N 990 are commercial products available from Evonik Degussa GmbH Advanced Fillers & Pigments, Rhenogran® MBTS-80 (2-mercaptobenzothiazole), Rhenogran® TBzTD-70 (tetrabenzyl thiuram disulfide) and Rhenogran® S-80 (sulfur) are commercial products available from Rhein Chemie, Perkadox BC-40B-PD is a commercial product available from AkzoNobel.

Apart from admixing the cross-linking and accelerator ingredients, the rubber mixtures were prepared in a laboratory mixer available from ThermoFischer (type HAAKE RheoDrive 7) at a rotor speed of 50 rpm, a till level of 60%, and a mixing time of 10 minutes. The ejection temperature was approximately 100° C. All further ingredients were homogenized in a second mixing stage using a lab roll made by Servitec (roll width 450 mm, roll distance 50 mm) using a friction of 1:1.25. The mixtures were vulcanized in a hydraulic lab press available from Servitec, type Polystat 300 S, at 200 bar.

Table 1 shows the formulations that were used and the mixture ingredients of mixture series 1, NBR rubber-based mixtures for diesel fuel pump diaphragms. Rubber mixtures 1 to 3 comprise conventional phthalate plastizicers and serve comparison purposes. In addition, NBR rubber mixtures comprising oleic acid methyl esters (mixtures 4 and 5), oleic acid ethyl esters (mixtures 6 and 7), oleic acid-2-ethylhexyl esters (mixtures 8 and 9), pentaerythritol dioleate (mixture 10), pentaerythritol tetraoleate (mixture 11) and linoleic acid-2-ethylhexyl ester (mixture 12) were produced.

TABLE 1
Formulations for mixture series 1

| Experiment | 1 | 2 | 3 | 4 | 5 | 6 |
|---|---|---|---|---|---|---|
| Formulation | Amount [phr] | | | | | |
| Perbunan ® 3945 | 100.0 | 100.0 | 100.0 | 100.0 | 100.0 | 100.0 |
| ZnO active | 5.0 | 5.0 | 5.0 | 5.0 | 5.0 | 5.0 |
| Stearic acid | 1.0 | 1.0 | 1.0 | 1.0 | 1.0 | 1.0 |
| Corax ® N660 | 65.0 | 65.0 | 65.0 | 65.0 | 65.0 | 65.0 |
| MT N990 | 15.0 | 15.0 | 15.0 | 15.0 | 15.0 | 15.0 |
| Rhenogran ® MBTS-80 | 3.1 | 3.1 | 3.1 | 3.1 | 3.1 | 3.1 |
| Rhenogran ® TBzTD-70 | 2.1 | 2.1 | 2.1 | 2.1 | 2.1 | 2.1 |
| Rhenogran ® S-80 | 0.5 | 0.5 | 0.5 | 0.5 | 0.5 | 0.5 |
| Dibutyl phthalate | 3.0 | | | | | |
| Di-isononyl phthalate | | 3.0 | 4.5 | | | |
| Oleic acid methyl ester | | | | 3.0 | 3.8 | |
| Oleic acid ethyl ester | | | | | | 3.0 |
| Oleic acid-2-ethylhexyl ester | | | | | | |
| Pentaerythritol dioleate | | | | | | |
| Pentaerythritol tetraoleate | | | | | | |
| Linoleic acid-2-ethylhexyl | | | | | | |
| ester | | | | | | |
| Experiment | 7 | 8 | 9 | 10 | 11 | 12 |
| Formulation | Amount [phr] | | | | | |
| Perbunan ® 3945 | 100.0 | 100.0 | 100.0 | 100.0 | 100.0 | 100.0 |
| ZnO active | 5.0 | 5.0 | 5.0 | 5.0 | 5.0 | 5.0 |
| Stearic acid | 1.0 | 1.0 | 1.0 | 1.0 | 1.0 | 1.0 |
| Corax ® N660 | 65.0 | 65.0 | 65.0 | 65.0 | 65.0 | 65.0 |
| MT N990 | 15.0 | 15.0 | 15.0 | 15.0 | 15.0 | 15.0 |
| Rhenogran ® MBTS-80 | 3.1 | 3.1 | 3.1 | 3.1 | 3.1 | 3.1 |
| Rhenogran ® TBzTD-70 | 2.1 | 2.1 | 2.1 | 2.1 | 2.1 | 2.1 |
| Rhenogran ® S-80 | 0.5 | 0.5 | 0.5 | 0.5 | 0.5 | 0.5 |
| Dibutyl phthalate | | | | | | |
| Di-isononyl phthalate | | | | | | |
| Oleic acid methyl ester | | | | | | |
| Oleic acid ethyl ester | 3.9 | | | | | |
| Oleic acid-2-ethylhexyl ester | | 3.0 | 5.0 | | | |
| Pentaerythritol dioleate | | | | 3.0 | | |
| Pentaerythritol tetraoleate | | | | | 3.0 | |
| Linoleic acid-2-ethylhexyl | | | | | | 3.0 |
| ester | | | | | | |

So as to obtain more information about the behavior of these plastizicers, the influence of various concentrations of plastizicers was analyzed.

The determination of the Mooney search values was carried out at 120° C. according to DIN 53523, Part 4. The determination of the Mooney viscosity values was carried out at 100° C. according to DIN 53523, Part 3. The determination of the vulcanization behavior was carried out at 170° C. according to DIN 53529. The determination of the Shore A hardness was carried out according to DIN 53505. The determination of the rebound resilience was carried out according to DIN 53512. The determination of the tensile strain behavior (tensile strain, tensile strength at break and modulus at 100% elongation) was carried out according to DIN 53504. The determination of the degree of swelling was carried out according to DIN 1817. The determination of compression set was carried out according to DIN 815.

Table 2 shows the results of the mixture examination and of the vulcanized rubber examination, including the physical characterization of the NBR rubber-based mixtures for diesel fuel pump diaphragms from Table 1.

TABLE 2
Mixture examination of the non-vulcanized rubber mixtures and
vulcanization examination of the mixtures from Table 1

| Experiment | | 1 | 2 | 3 | 4 | 5 | 6 |
|---|---|---|---|---|---|---|---|
| Non-vulcanized samples | | | | | | | |
| Mooney scorch, 120° C., | min | 11.5 | 11.9 | 12.3 | 12.0 | 11.9 | 11.8 |
| t5 | | | | | | | |
| Mooney scorch, 120° C., | min | 15.1 | 15.8 | 16.5 | 15.9 | 15.6 | 15.6 |
| t35 | | | | | | | |
| Mooney viscosity, | MU | 83.0 | 84.0 | 78.0 | 80.0 | 77.0 | 82.0 |
| 100° C. (ML 1 + 4) | | | | | | | |
| Fmin | dNm | 1.6 | 1.5 | 1.4 | 1.5 | 1.4 | 1.6 |
| Fmax | dNm | 23.4 | 22.5 | 22.8 | 22.6 | 20.8 | 22.9 |
| Fmax − Fmin | dNm | 21.8 | 21.0 | 21.4 | 21.1 | 19.4 | 21.3 |
| ts2 | min | 0.9 | 0.9 | 0.9 | 0.9 | 0.9 | 0.9 |
| t10 | min | 0.9 | 0.9 | 0.9 | 0.9 | 0.9 | 0.9 |
| t50 | min | 1.6 | 1.7 | 1.8 | 1.7 | 1.7 | 1.7 |
| t90 | min | 3.2 | 3.2 | 3.4 | 3.3 | 3.3 | 3.2 |
| Vulcanized rubber | | | | | | | |
| Hardness | Shore | 70.0 | 70.0 | 69.0 | 70.0 | 68.0 | 68.0 |
| | A | | | | | | |
| Rebound resilience | % | 18.0 | 18.0 | 19.0 | 20.0 | 21.0 | 20.0 |
| Tensile strain | % | 340.0 | 360.0 | 350.0 | 410.0 | 400.0 | 390.0 |
| Tensile strength at | MPa | 18.0 | 18.0 | 17.0 | 17.0 | 17.0 | 17.0 |
| break | | | | | | | |
| Modulus at 100% | MPa | 5.3 | 4.6 | 4.6 | 4.3 | 4.2 | 4.4 |
| elongation | | | | | | | |
| Swelling, 96 hrs at RT | % by | 0.1 | 0.3 | 0.1 | −0.1 | −0.1 | 0.5 |
| in isooctane | wt | | | | | | |
| Swelling, 96 hrs at | % by | 3.5 | 3.6 | 2.6 | 0.5 | 3.1 | 7.0 |
| 100° C. in IRM 903 | wt | | | | | | |
| Experiment | | 7 | 8 | 9 | 10 | 11 | 12 |
| Non-vulcanized samples | | | | | | | |
| Mooney scorch, 120° C., | min | 11.7 | 11.8 | 12.2 | 12.0 | 12.8 | 13.1 |
| t5 | | | | | | | |
| Mooney scorch, 120° C., | min | 15.5 | 15.6 | 15.9 | 15.9 | 16.7 | 17.5 |
| t35 | | | | | | | |
| Mooney viscosity, | MU | 77.0 | 84.0 | 75.0 | 87.0 | 89.0 | 84.0 |
| 100° C. (ML 1 + 4) | | | | | | | |
| Fmin | dNm | 1.5 | 1.6 | 1.4 | 1.6 | 1.8 | 1.7 |
| Fmax | dNm | 21.9 | 23.8 | 21.7 | 21.3 | 21.4 | 22.4 |
| Fmax − Fmin | dNm | 20.4 | 22.2 | 20.3 | 19.7 | 21.4 | 20.7 |
| ts2 | min | 0.9 | 0.9 | 0.9 | 0.9 | 0.9 | 0.9 |
| t10 | min | 0.9 | 0.9 | 0.9 | 0.9 | 0.9 | 0.9 |
| t50 | min | 1.6 | 1.6 | 1.6 | 1.7 | 1.8 | 1.8 |
| t90 | min | 3.2 | 3.2 | 3.1 | 3.3 | 3.3 | 3.4 |
| Vulcanized rubber | | | | | | | |
| Hardness | Shore | 68.0 | 70.0 | 68.0 | 70.0 | 69.0 | 70.0 |
| | A | | | | | | |
| Rebound resilience | % | 21.0 | 18.0 | 19.0 | 17.0 | 17.0 | 19.0 |
| Tensile strain | % | 400.0 | 380.0 | 400.0 | 360.0 | 380.0 | 400.0 |
| Tensile strength at | MPa | 17.0 | 17.0 | 16.0 | 17.0 | 17.0 | 17.0 |
| break | | | | | | | |
| Modulus at 100% | MPa | 4.1 | 4.6 | 3.8 | 4.3 | 4.6 | 4.3 |
| elongation | | | | | | | |
| Swelling, 96 hrs at RT | % by | −2.3 | 0.6 | 0.7 | 0.3 | 0.4 | 0.1 |
| in isooctane | wt | | | | | | |
| Swelling, 96 hrs at | % by | 3.0 | 4.2 | 3.4 | 4.5 | 5.7 | 3.8 |
| 100° C. in IRM 903 | wt | | | | | | |

The results from Table 2 show that mixtures 4 to 12, which are in accordance with the invention, exhibit comparable or better results than mixtures 1 to 3. The selected plastizicers, which are alternatives to phthalates, raise the Mooney search value slightly, which is an important practical benefit for several applications of the mixtures.

It is apparent from the Mooney viscosity values that the processability of all rubber mixtures is comparably good.

The vulcanization process of the rubber mixtures supplies useful information. The mixtures that comprised fatty acid esters of vegetable oils resulted in comparable cross-linking times as that of the reference (t90-t10), which is to say the mixtures comprising phthalates as plastizicers, which provides an opportunity for lowering costs in the production of rubber articles.

The hardness of rubber mixtures 4 to 12 is comparable to the hardness of the mixtures that comprise, as plastizicers, phthalates that are used conventionally. In addition, a slight increase in the rebound resilience of the rubber mixtures is achieved for the plastizicers that are used according to the invention.

It is particularly desirable for the tensile strain behavior to be preserved as compared to that which results for conventionally used phthalates. Values of rubber mixtures according to the invention that are comparable to the reference samples comprising phthalates as plastizicers were observed. Moreover, the values after artificial aging in various media do not show any disadvantages over the comparison examples. Higher degrees of swelling after aging in the reference liquid IRM 903 were noted for rubber mixtures 6 and 11.

Table 3 shows the formulations that were used and the mixture ingredients from mixture series 2, NBR rubber-based mixtures for O-rings. Rubber mixtures 13 and 14 comprise conventional phthalate plastizicers and serve comparison purposes. Mixtures 15 to 20 comprise various plastizicers, which according to the invention can be used in place of phthalate plastizicers.

TABLE 3
Formulations of mixture series 2

| | Experiment | | | |
|---|---|---|---|---|
| | 13 | 14 | 15 | 16 |
| Formulation | Amount [phr] | | | |
| Krynac ® 3345F | 100.0 | 100.0 | 100.0 | 100.0 |
| ZnO active | 3.0 | 3.0 | 3.0 | 3.0 |
| Corax ® N550 | 30.0 | 30.0 | 30.0 | 30.0 |
| Corax ® N772 | 45.0 | 45.0 | 45.0 | 45.0 |
| Vulkanox ® MB2/MG | 2.0 | 2.0 | 2.0 | 2.0 |
| Vulkanox ® HS/LG | 2.0 | 2.0 | 2.0 | 2.0 |
| Perkadox ® BC-40B-PD | 4.9 | 4.9 | 4.9 | 4.9 |
| Dibutyl phthalate | 9.0 | | | |
| Di-isononyl phthalate | | 9.0 | | |
| Oleic acid methyl ester | | | 9.0 | 7.7 |
| Oleic acid ethyl ester | | | | |
| Oleic acid-2-ethylhexyl ester | | | | |
| Linolenic acid-2-ethylhyexyl ester | | | | |
| Linoleic acid-2-ethylhexyl ester | | | | |
| | Experiment | | | |
| | 17 | 18 | 19 | 20 |
| Formulation | Amount [phr] | | | |
| Krynac ® 3345F | 100.0 | 100.0 | 100.0 | 100.0 |
| ZnO active | 3.0 | 3.0 | 3.0 | 3.0 |
| Corax ® N550 | 30.0 | 30.0 | 30.0 | 30.0 |
| Corax ® N772 | 45.0 | 45.0 | 45.0 | 45.0 |
| Vulkanox ® MB2/MG | 2.0 | 2.0 | 2.0 | 2.0 |
| Vulkanox ® HS/LG | 2.0 | 2.0 | 2.0 | 2.0 |
| Perkadox ® BC-40B-PD | 4.9 | 4.9 | 4.9 | 4.9 |
| Dibutyl phthalate | | | | |
| Di-isononyl phthalate | | | | |
| Oleic acid methyl ester | | | | |
| Oleic acid ethyl ester | 9.0 | | | |
| Oleic acid-2-ethylhexyl ester | | 9.0 | | |
| Linolenic acid-2-ethylhyexyl ester | | | 9.0 | |
| Linoleic acid-2-ethylhexyl ester | | | | 9.0 |

Table 4 shows the results of the mixture examination, of the vulcanized rubber examination, and the physical characterization of NBR rubber-based mixtures for O-rings from Table 3.

TABLE 4
Mixture examination of the non-vulcanized rubber mixtures and
vulcanized rubber examination of the mixtures from Table 3

| Experiment | | 13 | 14 | 15 | 16 |
|---|---|---|---|---|---|
| Non-vulcanized samples | | | | | |
| Mooney viscosity, 100° C. | MU | 88.8 | 88.8 | 79.0 | 83.0 |
| (ML 1 + 4) | | | | | |

Rheomether 2000, 170° C.

| | | | | | |
|---|---|---|---|---|---|
| Fmin | dNm | 2.2 | 2.4 | 2.3 | 2.6 |
| Fmax | dNm | 23.0 | 21.5 | 18.5 | 21.3 |
| Fmax − Fmin | dNm | 20.8 | 19.1 | 16.2 | 18.8 |
| ts2 | min | 0.7 | 0.7 | 0.9 | 0.7 |
| t10 | min | 0.7 | 0.7 | 0.8 | 0.7 |
| t50 | min | 2.6 | 2.6 | 2.7 | 2.5 |
| t90 | min | 7.8 | 7.5 | 7.4 | 7.1 |
| t90 − t10 | min | 7.1 | 6.8 | 6.6 | 6.4 |

Vulcanization, 15 min at 170° C.

| | | | | | |
|---|---|---|---|---|---|
| Vulcanized rubber | | | | | |
| Hardness | Shore A | 71.0 | 70.0 | 68.0 | 70.0 |
| Rebound resilience | % | 31.0 | 30.0 | 33.0 | 33.0 |
| Tensile strain | % | 250.0 | 250.0 | 270.0 | 250.0 |
| Tensile strength at break | MPa | 18.8 | 17.3 | 16.6 | 16.7 |
| Modulus at 100% elongation | MPa | 5.5 | 4.7 | 4.4 | 4.8 |

Swelling 70 hrs at 125° C. in IRM 903

| | | | | | |
|---|---|---|---|---|---|
| After swelling | | | | | |
| Degree of swelling | % by wt | 4.3 | 4.8 | 5.2 | 5.7 |
| Hardness | Shore A | 69.0 | 70.0 | 69.0 | 70.0 |
| Change in hardness | % | −2.8 | 0.0 | +1.5 | 0.0 |
| Tensile strain | % | 160.0 | 140.0 | 160.0 | 140.0 |
| Change in tensile strain | % | −36.0 | −44.0 | −40.7 | −44.0 |
| Tensile strength at break | MPa | 12.5 | 9.3 | 9.8 | 10.1 |
| Change in tensile strength at | % | −33.5 | −46.2 | −41.0 | −39.5 |
| break | | | | | |
| Modulus at 100% elongation | MPa | 3.0 | 5.7 | 5.3 | 6.6 |
| Change of modulus at 100% | % | −45.5 | +21.3 | +20.5 | +37.5 |
| elongation | | | | | |

Swelling 336 hrs at 125° C. in IRM 902

| After swelling | | | | | |
|---|---|---|---|---|---|
| Degree of swelling | % by wt | 0.5 | 0.6 | 0.6 | 0.4 |
| Hardness | Shore A | 71.0 | 69.0 | 71.0 | 71.0 |
| Change in hardness | % | 0.0 | −1.4 | +4.4 | +1.4 |
| Tensile strain | % | 190.0 | 180.0 | 220.0 | 210.0 |
| Change in tensile strain | % | −24.0 | −28.0 | −18.5 | −16.0 |
| Tensile strength at break | MPa | 18.1 | 15.7 | 17.2 | 18.0 |
| Change in tensile strength at | % | −3.7 | −9.2 | +3.6 | +7.8 |
| break | | | | | |
| Modulus at 100% elongation | MPa | 7.5 | 6.9 | 6.0 | 6.6 |
| Change of modulus at 100% | % | +36.4 | +46.8 | +36.4 | +37.5 |
| elongation | | | | | |
| Compressive set 70 hours at | % | 13 | 9 | 16 | 15 |
| 100° C. (25%) | | | | | |
| Experiment | | 17 | 18 | 19 | 20 |
| Non-vulcanized samples | | | | | |
| Mooney viscosity, 100° C. | MU | 82.0 | 86.0 | 84.0 | 83.0 |
| (ML 1 + 4) | | | | | |
| Fmin | dNm | 2.5 | 3.0 | 2.6 | 2.5 |
| Fmax | dNm | 20.4 | 23.9 | 18.1 | 18.4 |
| Fmax − Fmin | dNm | 17.9 | 20.9 | 15.5 | 15.9 |
| ts2 | min | 0.8 | 0.7 | 0.8 | 0.8 |
| t10 | min | 0.7 | 0.7 | 0.8 | 0.7 |
| t50 | min | 2.6 | 2.5 | 2.4 | 2.4 |
| t90 | min | 7.2 | 7.0 | 7.1 | 7.1 |
| t90 − t10 | min | 6.4 | 6.3 | 6.4 | 6.4 |

Vulcanization, 15 min at 170° C.

| | | | | | |
|---|---|---|---|---|---|
| Vulcanized rubber | | | | | |
| Hardness | Shore A | 68.0 | 71.0 | 72.0 | 70.0 |
| Rebound resilience | % | 34.0 | 30.0 | 32.0 | 32.0 |
| Tensile strain | % | 250.0 | 230.0 | 250.0 | 250.0 |
| Tensile strength at break | MPa | 16.5 | 17.6 | 15.8 | 16.2 |
| Modulus at 100% elongation | MPa | 4.6 | 6.0 | 5.1 | 5.1 |

Swelling 70 hrs at 125° C. in IRM 903

| | | | | | |
|---|---|---|---|---|---|
| After swelling | | | | | |
| Degree of swelling | % by wt | 5.0 | 4.5 | 6.1 | 5.2 |
| Hardness | Shore A | 71.0 | 70.0 | 69.0 | 69.0 |
| Change in hardness | % | +4.4 | −1.4 | −4.2 | −1.4 |
| Tensile strain | % | 140.0 | 130.0 | 150.0 | 160.0 |
| Change in tensile strain | % | −44.0 | −43.5 | −40.0 | −36.0 |
| Tensile strength at break | MPa | 1.4 | 9.4 | 9.2 | 10.3 |
| Change in tensile strength at | % | −37.0 | −46.6 | −41.8 | −36.4 |
| break | | | | | |
| Modulus at 100% elongation | MPa | 6.5 | 7.1 | 5.6 | 5.4 |
| Change of modulus at 100% | % | +41.3 | +18.3 | +9.8 | +5.9 |
| elongation | | | | | |

Swelling 336 hrs at 125° C. in IRM 902

| | | | | | |
|---|---|---|---|---|---|
| After swelling | | | | | |
| Degree of swelling | % by wt | 0.2 | 0.4 | 0.4 | -0.4 |
| Hardness | Shore A | 71.0 | 72.0 | 72.0 | 73.0 |
| Change in hardness | % | +4.4 | +1.4 | 0.0 | +4.3 |
| Tensile strain | % | 210.0 | 190.0 | 220.0 | 240.0 |
| Change in tensile strain | % | −16.0 | −17.4 | −12.0 | −4.0 |
| Tensile strength at break | MPa | 17.1 | 17.8 | 16.3 | 18.1 |
| Change in tensile strength at | % | +3.6 | +1.1 | +3.2 | +11.7 |
| break | | | | | |
| Modulus at 100% elongation | MPa | 6.3 | 8.0 | 5.9 | 6.2 |
| Change of modulus at 100% | % | +37.0 | +33.3 | +15.7 | +21.6 |
| elongation | | | | | |
| Compressive set 70 hours at | % | 16 | 14 | 16 | 15 |
| 100° C. (25%) | | | | | |

The Mooney viscosity value provides indications of the flow behavior during processing conditions. All plastizicers that were used according to the invention (see mixtures 15 to 20) lowered the Mooney viscosity.

Analyses in the rheometer provided information about the vulcanization behavior. The Ts2 times (increase in the degree of cross-linking by 2 units) of all plastizicer-containing mixtures are comparable to the reference mixtures. In addition, mixtures 15 to 20 exhibited faster cross-linking times (t90-t10) in comparison with the reference mixtures, which allows a cost reduction in the production of rubber articles.

The vulcanized rubber compositions were tested before and after aging in two reference liquids, IRM 903 (70 hours at 125° C.) and IRM 902 (336 hours at 125° C.). Of all the plastizicers that were used, linoleic acid-2-ethylhexyl ester (mixture 20) proved to be best substitute for phthalates.

After aging over 70 hours at 125° C. in the reference liquid IRM 903, the linoleic acid-2-ethylhexyl ester-containing vulcanized rubber mixture 20 exhibits the same behavior in terms of changes in hardness, tensile strain and tensile strength at break as the DBP-containing mixture (mixture 13), and better behavior than the DINP-containing mixture (mixture 14). The modulus at 100% elongation of the linoleic acid-2-ethylhexyl ester-containing mixture 20 increases slightly after aging (from 5.1 MPa to 5.4 MPa), while the modulus of the DBP-containing mixture 13 decreases from 5.5 MPa to 3.0 MPa.

After aging over 336 hours at 125° C. in the reference liquid IRM 902, the mixture comprising linoleic acid-2-ethylhexyl ester (mixture 20) exhibits considerably better behavior than the mixtures comprising DBP and DINP. The tensile strain of the linoleic acid-2-ethylhexyl ester-containing mixture 20 decreases by 4%, while the tensile strain of the DBP-containing mixture 13 decreases by 24% and that of the DINP-containing mixture 14 decreases by 28%. The tensile strength at break of the linoleic acid-2-ethylhexyl ester-containing mixture 20 increases by 11.7%, while the tensile strength at break for the two phthalate-containing mixtures, which comprise DBP and DINP, decreases by 3.7% and 9.2%, respectively. The results also show that the increase in the modulus at 100% elongation of the mixture comprising linoleic acid-2-ethylhexyl ester (mixture 20) is lower than that of the two mixtures comprising phthalates.

1-8. (canceled)

9. A rubber article comprising at least one plasticizer, which plasticizer is an oxygen-containing compound, characterized in that the oxygen-containing compound is a fatty acid ester of the general formula R¹—COOR², where R¹ is an alkyl radical or an alkenyl radical having 11 to 21 carbon atoms and/or R² is a linear or branched alkyl radical having 1 to 12 carbon atoms or a pentaerythritol group.

10. The rubber article according to claim 9, characterized in that the rubber is selected from the group of nitrile rubbers and chloroprene rubbers.

11. The rubber article according to claim 9, characterized in that R² is a methyl, ethyl, isopropyl 2-ethylhexyl or octyl radical.

12. The rubber article according to claim 9, characterized in that the fatty acid ester is selected from the group consisting of palmitic acid esters, stearic acid esters, oleic add esters, linoleic add esters, linolenic acid esters and erucic acid esters, and the mixtures thereof.

13. The rubber article according to claim 9, characterized in that the fatty acid ester is methyl oleate, ethyl oleate, 2-ethylhexyl oleate, pentaerythritol dioleate, pentaerythritol tetraoleate, 2-ethylhexyl stearate, 2-ethylhexyl linoleate or 2-ethylhexyl linoleate.

14. The rubber article according to claim 9, characterized in that the total amount of oxygen-containing plasticizer is 1 to 15 phr.

15. The rubber article according to claim 14, characterized in that the total amount of oxygen-containing plasticizer is 1 to 10 phr.

16. A hose, cable sheathing, seal, membrane, shoe sole, floor covering or damping devices, comprising the rubber article according to claim 9.
